(19) United States
(12) Patent Application Publication
(10) Pub. No.: US 2014/0361164 A1
(43) Pub. Date: Dec. 11, 2014

(54) ELECTRON BEAM INSPECTION APPARATUS

(71) Applicant: SAMSUNG ELECTRONICS CO., LTD., Suwon-si (KR)

(72) Inventors: Takashi OGAWA, Yokohama (JP); Yasutsugu USAMI, Yokohama (JP)

(21) Appl. No.: 14/295,565

(22) Filed: Jun. 4, 2014

(30) Foreign Application Priority Data
Jun. 7, 2013 (JP) 2013-121098
Feb. 3, 2014 (KR) 10-2014-0012215

(51) Int. Cl. G01N 23/22; G01N 23/227

(52) U.S. Cl. CPC G01N 23/2206; G01N 23/2273
USPC 250/305

(57) ABSTRACT

An electron beam inspection apparatus includes an electron beam irradiating unit, an electric field generating unit, an energy analyzing unit, and a detection unit. The electron beam irradiating unit irradiates an electron beam on a sample. The electric field generating unit generates an electric field in an irradiation direction of the electron beam. The energy analyzing unit analyzes energy of electrons emitted from the sample caused by emission of the electron beam, where the electrons are accelerated by the electric field. The detection unit detects a depth position of a portion to which the electrons are emitted in the irradiation direction of the electron beam based on a result of the energy analysis.

### CROSS-REFERENCE TO RELATED APPLICATION

Japanese Patent Application No. 2013-121098, filed on Jun. 7, 2013, and entitled: “Electron Beam Inspection Apparatus,” and Korean Patent Application No. 10-2014-0012215, filed on Feb. 3, 2014, with the same title are incorporated by reference herein in its entirety.

### BACKGROUND

1. Field

One or more embodiments described herein relate to an inspection apparatus.

2. Description of the Related Art

An electron beam apparatus detects a defect in a sample by scanning an electron beam irradiated from an electron gun. A defect is detected based on backscattered or secondary electrons emitted from a scanning spot.

In performing a detecting operation, the existence and position of a defect may be determined by charging a surface of the sample to a predetermined potential and then imaging the defect. During this operation, the strength and gradient of an applied electric field may be changed by adjusting a retarding voltage and the voltage of an intermediate electrode. This allows for detection of a stepped portion on a surface of the sample based on the backscattered or secondary electrons.

### SUMMARY

In accordance with one embodiment, an electron beam inspection apparatus includes an electron beam irradiating unit to irradiate an electron beam on a sample; an electric field generating unit to generate an electric field in an irradiation direction of the electron beam; an energy analyzing unit to analyze energy of electrons emitted from the sample caused by emission of the electron beam, the electrons accelerated by the electric field; and a detection unit to detect a depth position of a portion to which the electrons are emitted in the irradiation direction of the electron beam based on a result of the energy analysis.

The detection unit may detect a depth position of a defect based on a relationship between the energy of the electrons and a spectrum intensity based on the result of the energy analysis.

The energy analyzing unit may obtain characteristics indicating a relationship between the energy of the electrons and a spectrum intensity, the characteristics to be obtained by scanning pass energy of the emitted electrons, and the energy of the electrons to be analyzed based on the obtained characteristics.

The detection unit may detect the depth position based on the energy of the electrons at a peak position of the spectrum intensity in the obtained characteristics.

The apparatus may include a memory unit to store a correlation between the energy of the electrons and the depth position at the peak position of the spectrum intensity, wherein the detection unit is to detect the depth position based on a correlation stored in the memory unit.

The detection unit may detect the depth position of a defect generated in the sample based on the analyzed energy of the electrons. The electron beam irradiating unit may irradiate the electron beam as a beam having a size substantially equal to or greater than a width of a deep groove in the sample.

The apparatus may include a coordinate obtaining unit to obtain a coordinate of the defect, wherein the detection unit is to detect the depth position of the defect having the coordinate obtained by the coordinate obtaining unit. The electron beam irradiating unit may be provided in one electron beam column, and the electron beam inspection apparatus may includes at least one electron beam column.

In accordance with another embodiment, an apparatus includes at least one electron beam column including: an electron beam irradiating unit to irradiate an electron beam on a sample, and an energy analyzer to detect electrons emitted from the sample due to emission of the electron beam, the emitted electrons accelerated by an electric field; an electric field generating unit to generate the electric field in an irradiation direction of the electron beam to accelerate the emitted electrons; and a detection unit to receive an output signal from the energy analyzer, analyze energy of the electrons, and detect a depth position of a portion to which the electrons are emitted in the irradiation direction of the electron beam based on a result of the analysis.

The electric field generating unit may generate the electric field by applying a voltage between an objective lens of the electron beam irradiating unit and the sample, or by charging the sample with a predetermined number of electric charges.

The energy analyzer may include an energy filter having a grid electrode and a detector to detect electrons passing through the energy filter. The energy analyzer may include a path that includes concentric hemispheres and a detector that includes a slit and that detects the electrons. The energy analyzer may include a sector magnet having an electromagnet and a detector that includes a slit and that detects the electrons.

The apparatus may include a plurality of electron beam columns; and two or more control power supply sources respectively allocated to the two or more electron columns and to input a scan voltage into the two or more electron columns.

In accordance with another embodiment, an electron beam inspection apparatus includes an irradiator to direct an electron beam on a sample; a generator to generate an electric field for the electron beam; an analyzer to analyze energy of electrons emitted from the sample; and a detector to detect a depth position of the emitted electrons based on a result of the energy analysis, wherein the depth position is in alignment with a direction in which the electron beam is directed toward the sample.

The electric field extends between an end of an electron beam column and the sample. The electrons emitted from the sample may be accelerated by the electric field. The detector may detect the depth position based on a comparison of peak positions of energy of the electrons emitted from the sample. The depth position of the emitted electrons may correspond to a contact hole in the same which includes a semiconductor wafer.

### BRIEF DESCRIPTION OF THE DRAWINGS

Features will become apparent to those of skill in the art by describing in detail exemplary embodiments with reference to the attached drawings in which:

FIG. 1 illustrates an embodiment of an electron beam inspection apparatus;

FIG. 2 illustrates an electron beam column of the electron beam inspection apparatus of FIG. 1;

FIG. 3 illustrates an end portion of the electron beam column and a sample;

FIGS. 4A to 4D illustrate examples of results obtained after calculating an orbit of a secondary electron beam generated when a depth position of a defect in a contact hole is changed;

FIG. 5 illustrates an example of a relationship between a spectrum intensity (horizontal axis) and energy (vertical axis) of the secondary electron beam;

FIG. 6 illustrates an example of a relationship between a spectrum intensity (horizontal axis) and energy (vertical axis) of an electron beam at a position of a defect;

FIG. 7 illustrates an example of a relationship between a variation of energy and a position (depth) of a defect;

FIG. 8 illustrates an embodiment of an energy analyzer;

FIG. 9 illustrates an embodiment of a detector and energy filter in the analyzer;

FIG. 10 illustrates another embodiment of an energy analyzer;

FIG. 11 illustrates another embodiment of an energy analyzer;

FIG. 12 illustrates a an embodiment of an electron beam column using a magnetic lens in an electron beam inspection apparatus;

FIG. 13 illustrates an embodiment of a defect inspection process; and

FIG. 14 illustrates another embodiment of an electron beam inspection apparatus including a plurality of the electron beam columns in a chamber unit.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

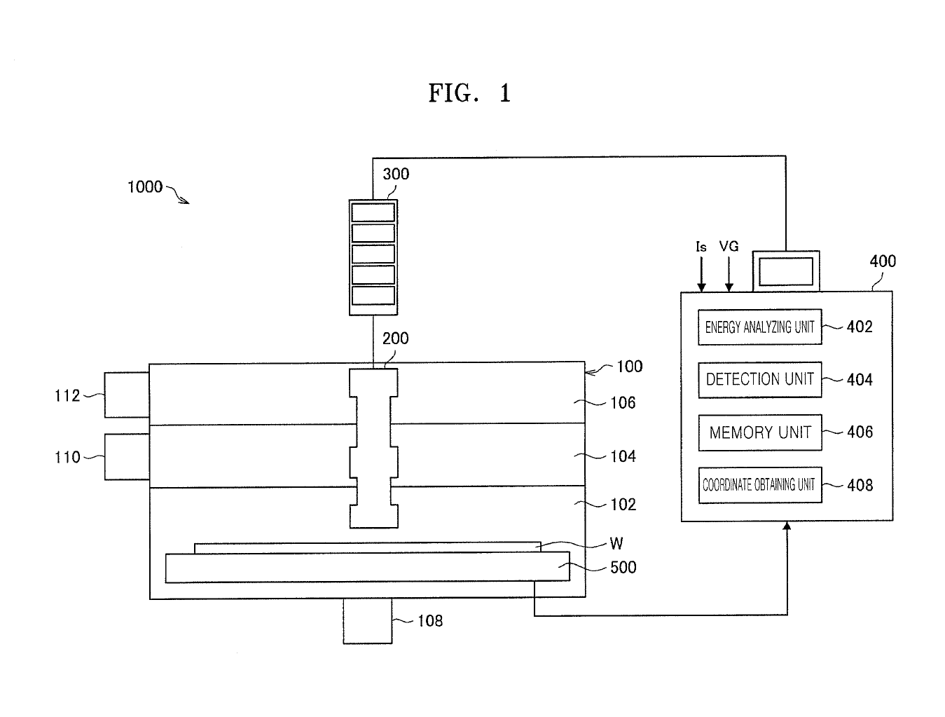

FIG. 1 illustrates an embodiment of an electron beam inspection apparatus 1000 which includes a chamber unit 100, one electron beam column 200 in chamber unit 100, a control power supply source 300 connected to electron beam column 200, and a computer 400 connected to control power supply source 300.

The chamber unit 100 includes a first chamber (wafer chamber) 102, a second chamber (intermediate chamber) 104, and a third chamber (electron gun chamber) 106. The first chamber 102, second chamber 104, and third chamber 106 may be independent spaces disposed adjacent to one another. Vacuum pumps 108, 110, and 112 are provided for maintaining interior spaces of the first through third chambers at predetermined degrees of vacuum. The electron beam column 200 may pass through the first to third chambers 102, 104, and 106.

A stage 500 may serve to support a sample, which, for example, may be a wafer W. The stage may be located in first chamber 102. The wafer W is placed on a top surface of stage 500. The stage 500 may be formed to move in one or more predetermined directions along a main surface of the wafer W. The stage may move wafer W at a predetermined speed in a predetermined direction during inspection. When electron beam column 200 detects a defect on wafer W, a coordinate of the defect in at least one predetermined (e.g., horizontal) direction may be detected based on a position of stage 500.

The control power supply source 300 inputs a scan voltage to electron beam column 200. The control power supply source 300 is provided to electron beam column 200. Examples of a signal output from control power supply source 300 include a highly stable voltage, a high-voltage current added to a predetermined current, and a high-frequency current.

Control power supply source 300 may further include a correction mechanism. The correction mechanism may perform correction on signals output from control power supply source 300. This correction may include, for example, correction of a phase difference of a high-frequency voltage, correction of a wait time of a scanning signal, and/or change of a control current circuit such as a filter.

The computer 400 inputs a control command for electron beam column 200, and forms an image of a wiring pattern based on an output signal of a secondary electron beam reflecting a shape of the wiring pattern. The image may be obtained by irradiating an electron beam to wafer W. A mode in which a defect is detected by forming an image may be referred to as a “typical defect detection mode”.

Computer 400 detects a depth of a defect based on the output signal of the secondary electron beam. In one embodiment, computer 400 includes an energy analyzing unit 402, a detection unit 404, a memory unit 406, and a coordinate obtaining unit 408. The elements of computer 400 may be configured as hardware (circuit) such as a central processing unit (CPU), controller, or other processor, and/or a program (software) for operating the CPU, controller, or processor.

The electron beam inspection apparatus 1000 may detect not only existence of a defect in an area and a position of the defect in a planar direction, but also a position of the defect in a depth direction. For example, electron beam inspection apparatus 1000 may respond to a demand to detect a position in a depth direction of a semiconductor substrate in order to detect a defect in a contact hole, as a transistor having a three-dimensional (3D) structure such as a V-NAND structure has recently been developed and an aspect of a contact hole formed in a semiconductor substrate has increased.

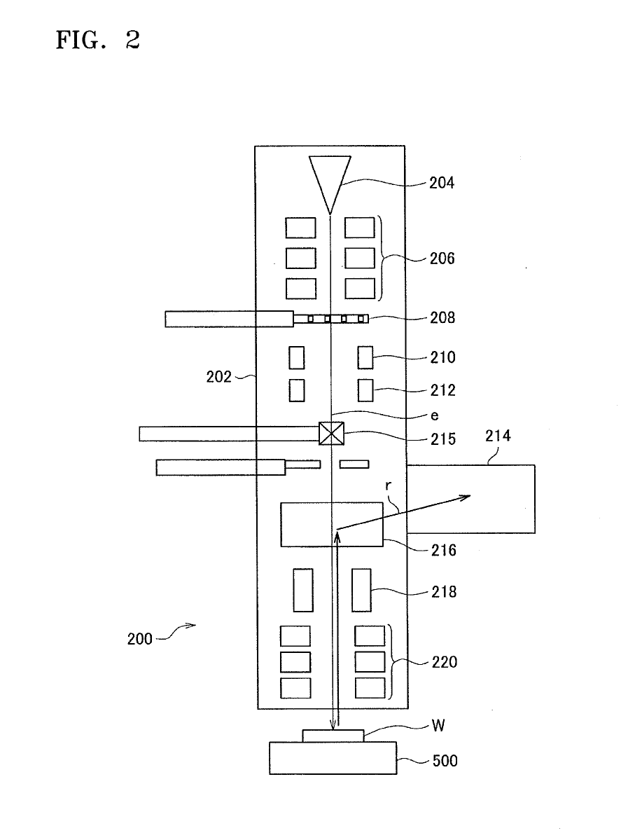

FIG. 2 illustrates an embodiment of electron beam column 200 of electron beam inspection apparatus 1000. Referring to FIG. 2, electron beam column 200 includes an outer body 202 having a long cylindrical shape. The outer body 202 may be formed of a metal and may have a central axis. A plurality of degassing holes through which an inside of outer body 202 is subject to a vacuum may be formed in outer body 202. A degree of vacuum of an area through which an electron beam e passes may be increased due to the degassing holes.

A plurality of electron beam optical elements may be received in outer body 202 of electron beam column 200. For example, an electron gun 204, condenser lens 206, electron beam aperture mechanism 208, optical axis-adjusting mechanism 210, blanking electrode 212, valve 215, energy analyzer 214, beam splitter 216, scanning electrode 218, and objective lens 220 are sequentially disposed in outer body 202. The condenser lens 206, electron beam aperture mechanism 208, optical axis-adjusting mechanism 210, blanking electrode 212, beam splitter 216, scanning electrode 218, and objective lens 220 are concentrically disposed around the central axis.

The electron gun 204 may be, for example, a Schottky electron gun or a thermal field emission electron gun. The electron beam e is emitted by adjusting an acceleration voltage and applying the adjusted acceleration voltage to electron gun 204. The condenser lens 206 and electron beam aperture mechanism 208 condense and adjust electron beam e emitted from electron gun 204 to have a desired current.

The optical axis-adjusting mechanism 210 functions to correct astigmatism of electron beam e, and to adjust a position of electron beam e on an optical axis and a position of electron beam e irradiated onto the sample.

The blanking electrode 212 may temporarily block electron beam e in order to not irradiate electron beam e to wafer W on stage 500. The blanking electrode 212 may deviate the electron beam from electron gun 204 in order to not irradiate electron beam e to wafer W.

The valve 215 may divide the first chamber 102, second chamber 104, and third chamber 106 in electron beam column 200. The valve 215 may be used to divide each chamber, so that second chamber 104 and third chamber 106 are not opened to air when, for example, first chamber 102 is in an abnormal state. The valve 215 may be omitted from electron beam column 200 in an alternative embodiment.

The energy analyzer 214 detects a secondary electron beam r that includes at least one of secondary electrons, Auger electrons, or backscattered electrons emitted along a surface of wafer W, when electron beam e is irradiated on wafer W. The energy analyzer 214 analyzes energy of emitted electrons. (Hereinafter, it is assumed that secondary electron beam r includes secondary electrons, Auger electrons, or backscattered electrons generated by emission of electron beam e).

The energy analyzer 214 has an energy resolution equal to or less than, for example, about 1 eV. The beam splitter 216 separates the emitted secondary electron beam r from the optical axis and introduces secondary electron beam r to energy analyzer 214.

A detection signal of energy analyzer 214 is transmitted outside electron beam column 200. The transmitted detection signal of energy analyzer 214 is amplified by, for example, a preamplifier, is changed to digital data by an analog-to-digital (AD) converter, and is input to computer 400.

The electron beam e is deflected by applying a high-frequency control signal (electrical signal), for example, a high-frequency current ranging from about 0 V to about 400 V, from outside to scanning electrode 218. The electron beam e may be deflected by applying a control signal to scanning electrode 218. The electron beam e may be scanned in one or more predetermined directions across the main surface of wafer W. The high-frequency control signal may be applied to scanning electrode 218 from the outside of electron beam column 200. The objective lens 220 focuses electron beam e that is deflected by scanning electrode 118 on the main surface of wafer W.

In this structure, electron beam e emitted from electron gun 202 is scanned onto the main surface of wafer W. The secondary electron beam r (that includes secondary electrons, Auger electrons, and/or backscattered electrons reflecting a shape, a structure, or a charging state of a circuit pattern) is detected by energy analyzer 214. An image of a defect and/or the circuit pattern on the main surface of wafer W may be obtained by processing a detection signal of the detected secondary electron beam r in computer 400. This may accomplished, for example, by using the preamplifier or AD converter, and the defect on the wafer W may be detected in a typical defect detection mode. Also, electron beam inspection apparatus 1000 may detect the depth of the defect.

The stage 500, or each of the electron beam optical elements in the electron beam column 200, may be received in a chamber corresponding to an appropriate degree of vacuum among first through third chambers 102, 104, and 106 in chamber unit 100. For example, electron gun 204 and condenser lens 206 may be disposed in third chamber 106 set to have a highest degree of vacuum.

The electron beam aperture mechanism 208, optical axis-adjusting mechanism 210, and blanking electrode 212 are disposed in second chamber 104, set to have a degree of vacuum next to the highest degree of vacuum. The energy analyzer 214, beam splitter 216, scanning electrode 218, objective lens 220, and stage 500 on which wafer W is placed are disposed in first chamber 102, set to have a lowest degree of vacuum. Accordingly, because there is no need to maintain the electron beam optical elements, stage 500, and wafer W at a high degree of vacuum in order to emit electron beam e, the structure may be simplified.

Next, a method of detecting a depth of a defect by using the electron beam inspection apparatus 1000 will now be explained. An oxide film such as a silicon oxide film is formed on a surface of wafer W. A deep groove such as a contact hole is formed in the oxide film. Electron beam inspection apparatus 1000 may be used to inspect wafer W on which the oxide film having a deep groove (e.g., a contact hole) is formed.

In this method, an electric field is applied between an end of objective lens 220 and wafer W. The electric field forms a potential gradient in the deep groove formed in the oxide film of wafer W. Alternatively, a potential gradient may be formed by charging wafer W with a predetermined number of electric charges.

The secondary electron beam r emitted from wafer W, due to application of electron beam e, has its own energy. Because there is an energy difference between defects having different positions (e.g., depths) in the deep groove of the oxide film due to a potential gradient, a depth of each defect may be detected by analyzing the energy of the emitted electrons. In addition, in the case of backscattered electrons, because an energy difference between incidence and emission is compensated for (and thus there may be no energy difference), the backscattered electrons may not be used to detect depth in all circumstances.

A method of detecting depth using electron beam inspection apparatus 1000 will now be explained in greater detail. The method may be applied to inspect a sample in the form of a semiconductor wafer that has an insulator with a deep hole or a deep groove (such as a contact hole). In other embodiments, a sample different from a a semiconductor wafer may be inspected. For example, the sample may be a liquid crystal substrate or an organic light-emitting device substrate. In one non-limiting example, electron beam inspection apparatus 1000 may be applied to inspect a sample on which a insulator having a thickness equal to or greater than 100 nm is formed.

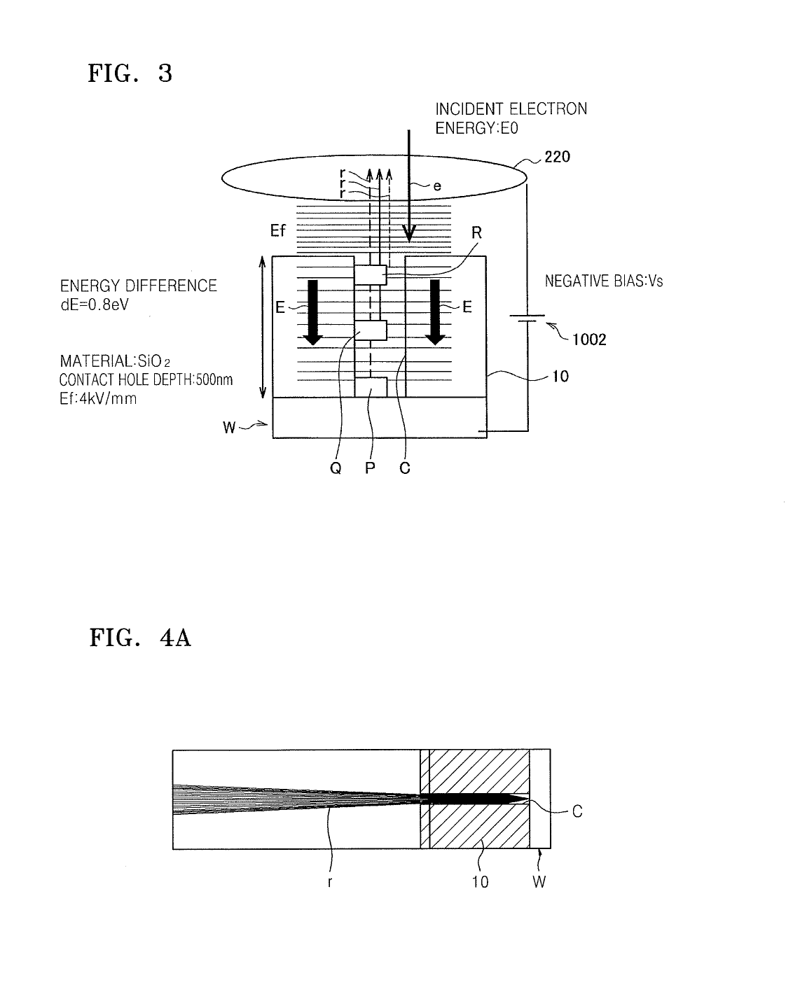

FIG. 3 is a cross-sectional view illustrating an end portion of electron beam column 200 and the sample of FIG. 2. Referring to FIG. 3, an insulating film (silicon oxide film formed of SiO2) 10 is formed on a surface of wafer W that serves as the sample. A contact hole C is formed as a deep hole in insulating film 10. For example, a depth of the contact hole C may be 500 nm.

As shown in FIG. 3, electron beam inspection apparatus 1000 may include an electric field generating unit 1002 that generates an electric field by applying a predetermined voltage between wafer W and objective lens 220. A negative voltage is applied to wafer W. As a result, an electric field E is generated in an irradiation direction of an electron beam (e.g., a depth direction of the contact hole C).

Also, in FIG. 3, a voltage is applied to generate an electric field of 4 kV/mm in the depth direction of contact hole C. Thus, an energy difference dE between a bottom of contact hole C and a surface of insulating film 10 is calculated to be about 0.8 eV. Also, as shown in FIG. 3, electric field Ef is generated between a surface of wafer W and objective lens 220. The electric field E is calculated using a dielectric constant ∈ and a thickness of the insulating film 10.

A signal Is (see FIG. 1) is input into computer 400. The signal Is indicates a spectrum intensity of secondary electron beam r detected by energy analyzer 214 and an adjusted voltage VG (see FIG. 1) of an energy filter 230 (see FIG. 8). The computer 400 calculates a potential distribution at a depth position in contact hole C and an energy difference of the emitted secondary electron beam r from a material of the sample, a thickness of insulating film 10, a working distance (e.g., a distance between an end of the objective lens 220 and the wafer W), a voltage of the sample, and a quantity of electric charge which have been previously input.

As shown in FIG. 3, it is assumed that defects P, Q, and R exist at different depth positions in contact hole C. The electron beam e is irradiated onto defects P, Q, and R, and secondary electron beam r is generated from each of the depth positions of defects P, Q, and R. The secondary electron beam r is accelerated by electric field E, and is detected by energy analyzer 214 of electron beam column 200.

Because secondary electron beams r generated in defects P, Q, and R have different distances between defects P, Q, and R and objective lens 220, secondary electron beams r are accelerated differently by electric field E. The secondary electron beam r that is generated in defect P at a deepest position in contact hole C has a greatest distance accelerated by electric field E, and thus has the highest energy. The secondary electron beam r generated in defect R that exists at a shallowest position in contact hole C has a short distance accelerated by electric field E, and thus has a lowest energy. Accordingly, a depth position of a defect in contact hole C may be detected based on an energy difference.

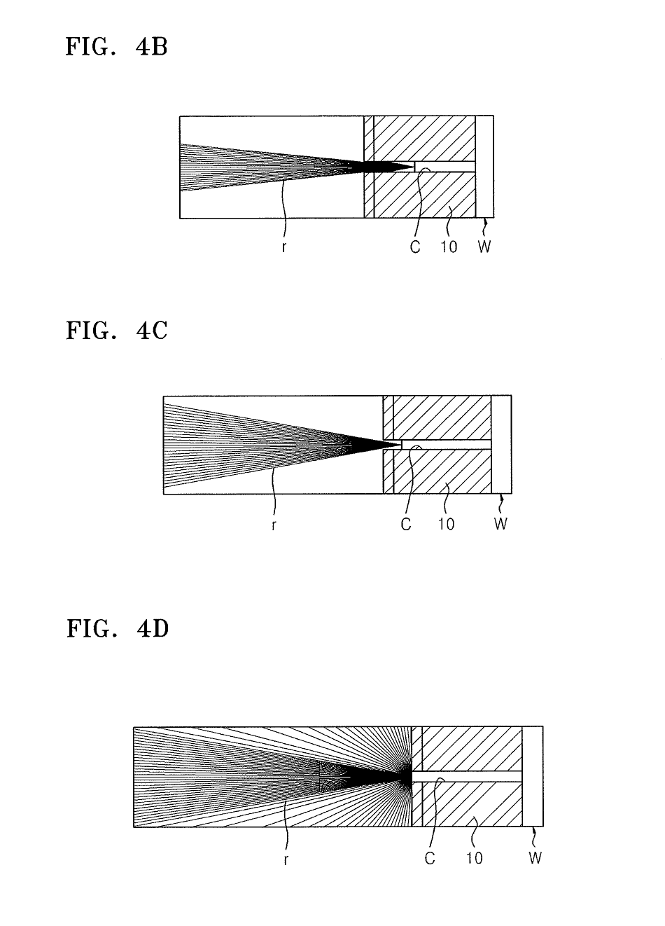

FIGS. 4A to 4D illustrate examples of simulation results obtained after calculating an orbit of a secondary electron beam generated when a depth position of a defect in contact hole C is changed. FIG. 4A illustrates an orbit of secondary electron beam r generated at the bottom of contact hole C. FIG. 4B illustrates an orbit of secondary electron beam r generated at a position slightly higher than a middle depth of contact hole C. FIG. 4C illustrates an orbit of secondary electron beam r generated at a depth position relatively close to a surface of insulating film 10 in contact hole C. FIG. 4D illustrates an orbit of secondary electron beam r generated at a position on the surface of insulating film 10.

As shown in FIG. 4A, when secondary electron beam r is generated at the bottom of contact hole C, the accelerated secondary electron beam r collides with a side wall of contact hole C and is relatively narrow. In this case, energy of secondary electron beam is the highest. In contrast, as shown in FIG. 4D, when secondary electron beam r is generated at the surface of the sample, the accelerated secondary electron beam r is radially diffused from the defect. In this case, energy of the secondary electron beam r is the lowest. FIGS. 4B and 4C show secondary electron beams r generated at intermediate positions of the contact hole C with corresponding intermediate energies.

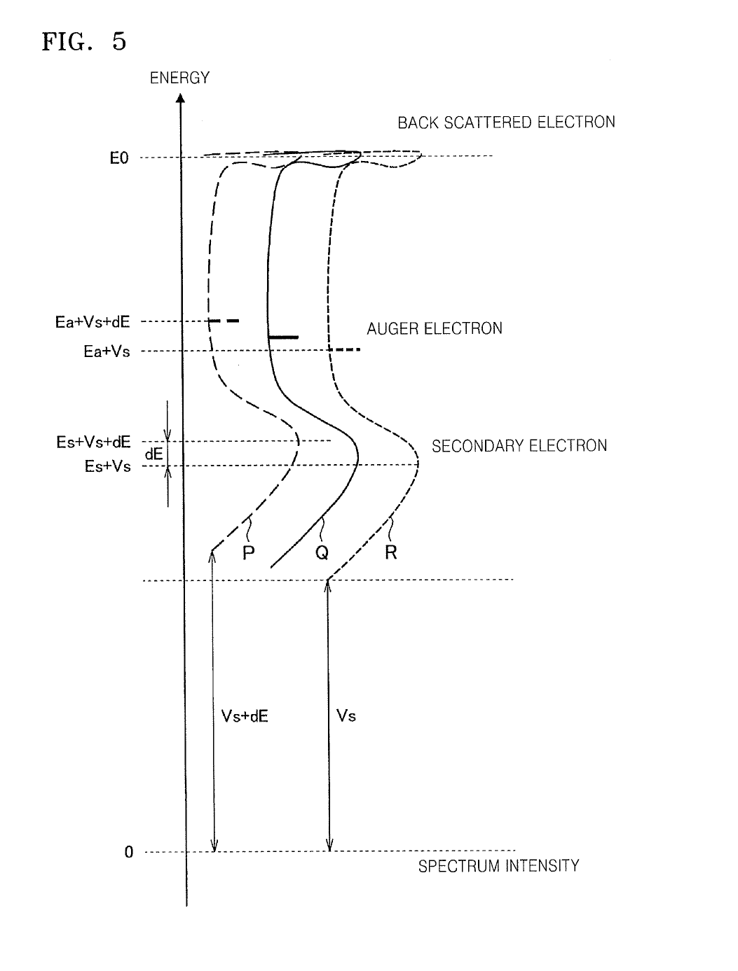

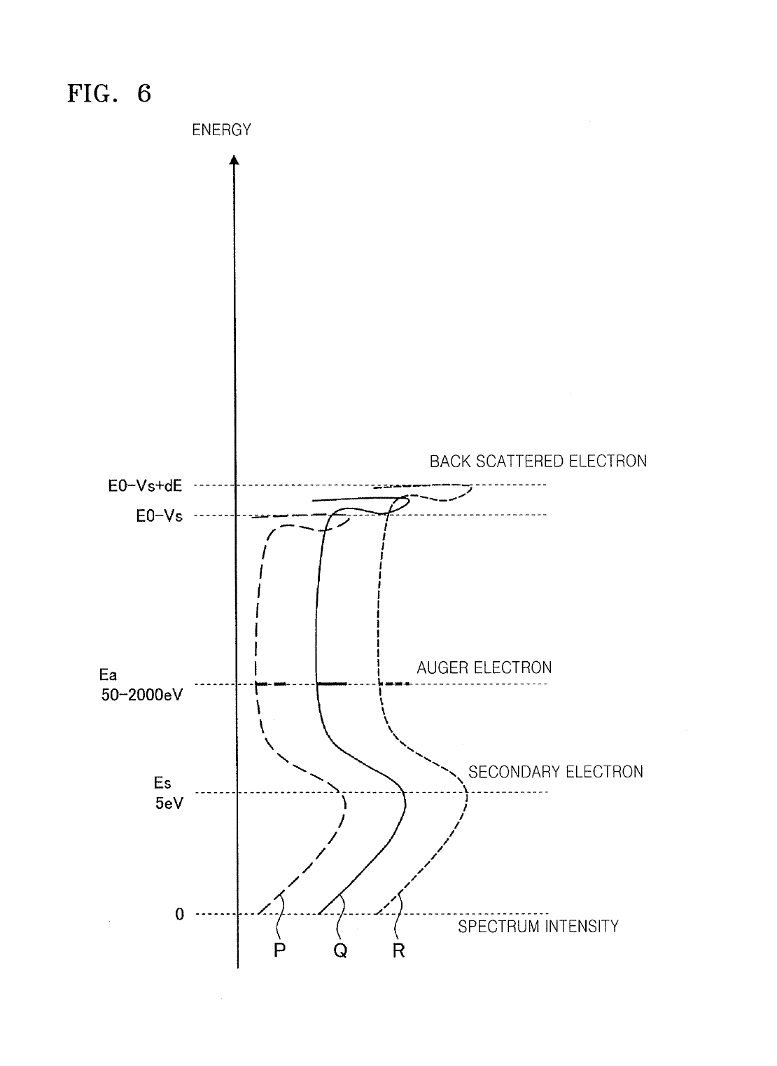

FIG. 5 is a graph illustrating a relationship between a spectrum intensity (horizontal axis) and energy (vertical axis) of secondary electron beam r generated for each of the defects P, Q, and R as detected by energy analyzer 214. FIG. 6 is a graph illustrating a relationship between a spectrum intensity (horizontal axis) and energy (vertical axis) of electron beam e at a position of each of defects P, Q, and R. Although values of characteristics of defects P, Q, and R in the horizontal axis are the same in FIGS. 5 and 6, the characteristics are alternately shown in the horizontal direction in order to easily compare characteristics of the defects P, Q, and R.

Referring to FIGS. 5 and 6, three peaks are shown. These peaks are a peak of secondary electrons, a peak of Auger electrons, and a peak of backscattered electrons. These peaks correspond to characteristics indicating a relationship between spectrum intensity and energy. As shown in FIG. 6, energies at peaks (of secondary electrons and Auger electrons) in defects P, Q, and R, are the same in characteristics at positions of the defects P, Q, and R.

As shown in FIG. 5, in characteristics detected by energy analyzer 214, energy of the secondary electron beam r generated in defect P is higher by Vs+dE than energy at a position of defect P of FIG. 6. This is because the secondary electron beam r is accelerated by electric field E, which increases the energy of secondary electron beam r. dE may be calculated from a dielectric constant and a thickness of an insulator of the sample and electric field E.

Also, as shown in FIG. 5, in the characteristics detected by energy analyzer 214, energy of the secondary electron beam r generated in defect R is higher by Vs than energy of defect R of FIG. 6. That is, in the characteristics of FIG. 5, energy of the secondary electron beam r generated in defect R is lower by dE from energy of secondary electron beam r generated in defect P. This is because a distance of secondary electron beam r generated in defect P, which is accelerated by electric field E, is greater than that of secondary electron beam r generated in defect R as described above. In the above calculation, because an energy difference between the bottom of contact hole C and a surface of insulating film 10 is 0.8 eV, defect P is disposed at the bottom of contact hole C, and defect R is disposed on the surface of insulating film 10, dE corresponds to 0.8 eV.

Accordingly, when energy at a peak position of secondary electrons and energy at a peak position of Auger electrons are compared as characteristics of defect P and defect R, energy of defect P is higher by dE than energy of defect R. Accordingly, a depth of a defect may be detected based on a peak position detected by energy analyzer 214, by previously obtaining a relationship between the depth of the defect and the peak position detected by energy analyzer 214.

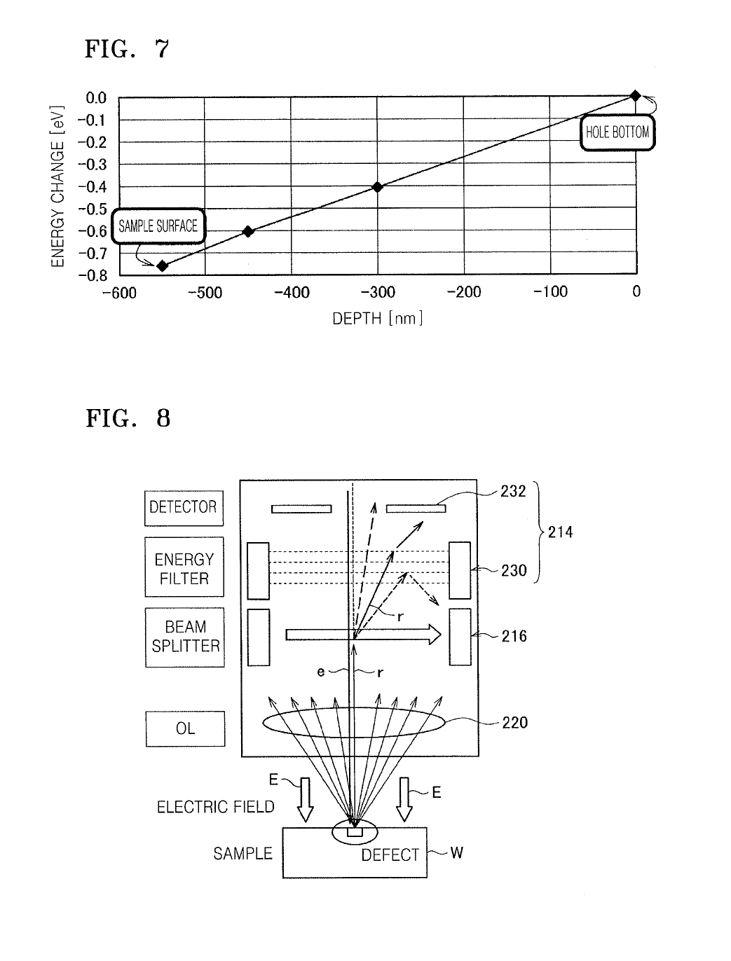

FIG. 7 is a graph illustrating an example of a relationship between a position (depth, vertical axis) of a defect and a variation (horizontal axis) of energy. In FIG. 7, characteristics are illustrated corresponding to when an electric field of 4 kV/mm is applied to a silicon oxide film formed of SiO₂, having a thickness of 550 nm used as the insulating film 10.

Referring to FIG. 7, an energy difference of about 0.8 eV exists between a surface of wafer W (e.g., surface of the insulating film 10) and the bottom of contact hole C. Thus, energy increases in proportion to the depth of a defect. Accordingly, a depth position of the defect may be detected by measuring a peak position of secondary electrons, a raised position of secondary electrons, and/or a peak position of Auger electrons.

For example, a peak position of an Auger spectrum for SiO₂ is about 92 eV in silicon (Si) (LVV), about 1730 eV in Si (KLL), and about 500 eV in oxygen (O) (KLL). Accordingly, as shown in FIG. 6, the peak position of the Auger spectrum ranges from about 50 eV to about 2000 eV. Accordingly, a depth of a defect may be detected by measuring a peak position of secondary electrons, a raised position of secondary electrons, and a peak position of Auger electrons, and then comparing these positions with peak positions when electric field E is not applied. For reference, characteristics of FIG. 5 may be detected using energy analyzer 214. The energy analyzer 214 will now be explained in more detail.

FIG. 8 illustrates an embodiment of energy analyzer 214 in electron beam inspection apparatus 1000. Referring to FIG. 8, energy analyzer 214 may include energy filter 230 as a retarding grid and a detector 232. As shown in FIG. 8, a secondary electron beam generated in each of defects P, Q, and R is initially incident on beam splitter 216, passes through energy filter 230, and is then incident on detector 232.

The beam splitter 216 applies a magnetic field in a vertical direction (e.g., perpendicular to ground) of FIG. 8, and applies an electric field in a direction (e.g., horizontal direction) perpendicular to the magnetic field. The beam splitter 216 enables electron beam e irradiated from electron gun 204 to reach the sample without deviating, by optimally adjusting the magnetic field and electric field. The beam splitter 216 also enables the generated secondary electron beam r to deviate from the central axis of the electron beam column 200 and to reach detector 232.

In addition, examples of detector 232 may include a semiconductor detector, a scintillator and photomultiplier tube (PMT), a channel electron multiplier (CEM), and a microchannel plate. Each of the detectors amplifies input electrons and outputs the amplified electrons as a current signal. Also, energy may be analyzed at a higher speed by parallelizing a plurality of the detectors in an array. The current signal is changed to a voltage by the preamplifier disposed on a rear end of detector 232 to be amplified, digitized by the AD converter, and transmitted to computer 400.

The energy filter 230 applies a negative potential VG to secondary electron beam r and enables the same to be incident on detector 232 to correspond to energy of secondary electron beam r. Characteristics indicating a relationship between energy and a spectrum intensity of FIG. 5 are obtained by adjusting energy (pass energy) of a passing secondary electron beam. This may be accomplished by adjusting negative potential VG using energy filter 230 and differentiating an obtained curve.

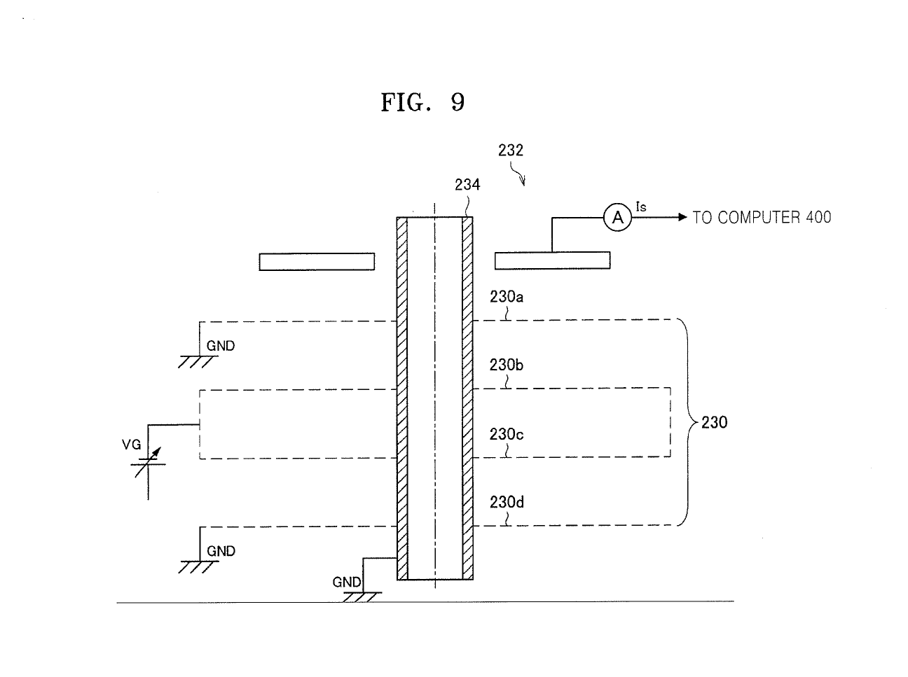

FIG. 9 illustrates an embodiment of a structure of detector 232 and energy filter 230 in energy analyzer 214 of FIG. 8. Referring to FIG. 9, energy filter 230 includes four grid electrodes 230a, 230b, 230c, and 230d that extend in a horizontal direction. A negative potential (e.g., an adjustment voltage) VG is applied to two central grid electrodes 230b and 230c. A ground potential GND is applied to grid electrodes 230a and 230d located at the top and bottom.

Also, detector 232 detects a current Is generated by incident secondary electron beam r, and current Is indicates a spectrum intensity (corresponding to a horizontal axis of FIG. 5) of secondary electron beam r. Characteristics of FIG. 5 may be obtained by detecting current Is while changing adjustment voltage VG and plotting the adjustment voltage VG to a vertical axis and current Is to the horizontal axis.

As shown in FIG. 9, because a container 234 that is grounded is provided at a center location, electron beam e may pass through energy filter 230 without being affected by change in adjustment voltage VG. In addition, an energy window that corresponds to a range of energy detected at one time is a value determined by a shape or a size of energy analyzer 214 and a potential difference between grid electrodes 230b and 230c.

An energy spectrum may be obtained by scanning pass energy while the energy window is kept constant. For example, when the energy spectrum is to be obtained at a high resolution, the energy window is set to be small. When the energy spectrum is to be obtained at a high speed, the energy window may be set to be large.

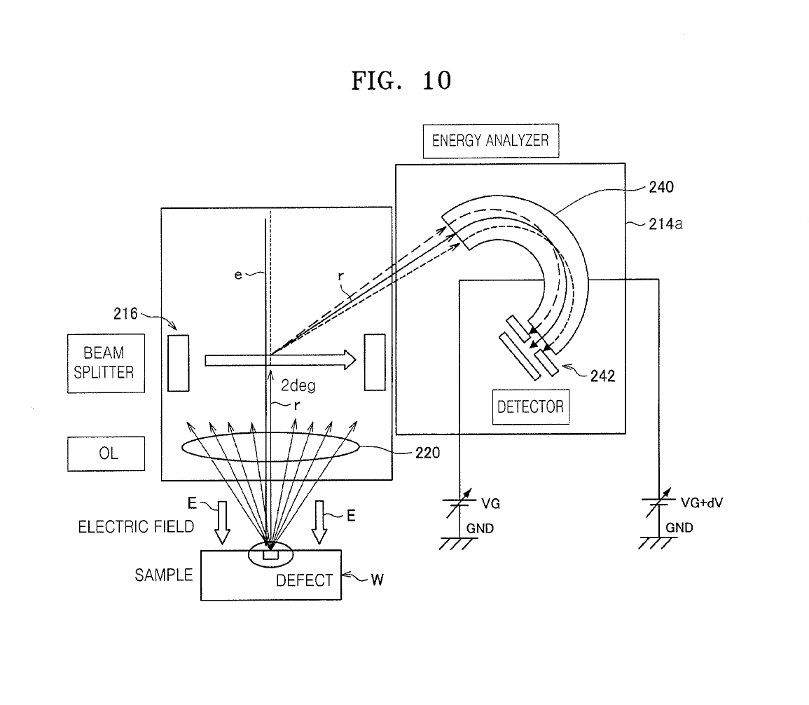

FIG. 10 illustrates another embodiment of an energy analyzer 214a in electron beam inspection apparatus 1000. In FIG. 10, energy analyzer 214a includes a detector 242 and a path 240 that includes two concentric hemispheres facing each other. A secondary electron beam r split by beam splitter 216 is introduced into path 240. An adjustment voltage VG is applied to an inner circumferential surface and VG+dV is applied to an outer circumferential surface of the two hemispheres of path 240. The detector 242 includes a slit and detects a current Is for secondary electron beam r that is incident. Current Is indicates a spectrum intensity (e.g., corresponding to a horizontal axis of FIG. 5) of secondary electron beam r.

Accordingly, even in energy analyzer 214a of FIG. 10, characteristics of FIG. 5 may be obtained by detecting current Is while changing adjustment voltage VG and plotting adjustment voltage VG to a vertical axis and current Is to the horizontal axis.

Also, an energy window may be adjusted using dV, since the energy window (energy width) of the secondary electron beam r is determined by a shape (e.g., a radius, angle, or slit width at the back) of the energy analyzer 214a and a potential difference dV of the hemispheres. For example, when an energy spectrum is to be obtained at a high resolution, the energy window is set to be small. When the energy spectrum is to be obtained at a high speed, the energy window is set to be large. The path 240 functions to set the energy window detected from an energy difference. The energy window is set to be, for example, equal to or less than 1/10 of the energy difference.

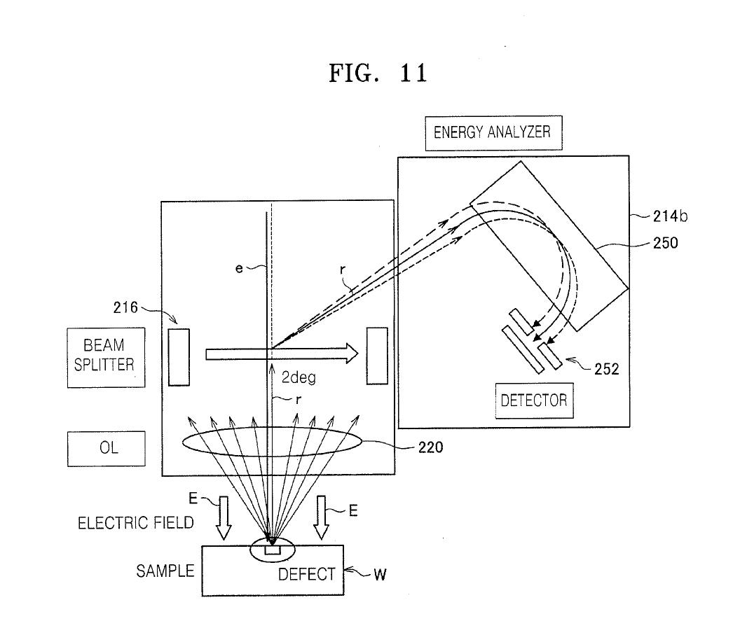

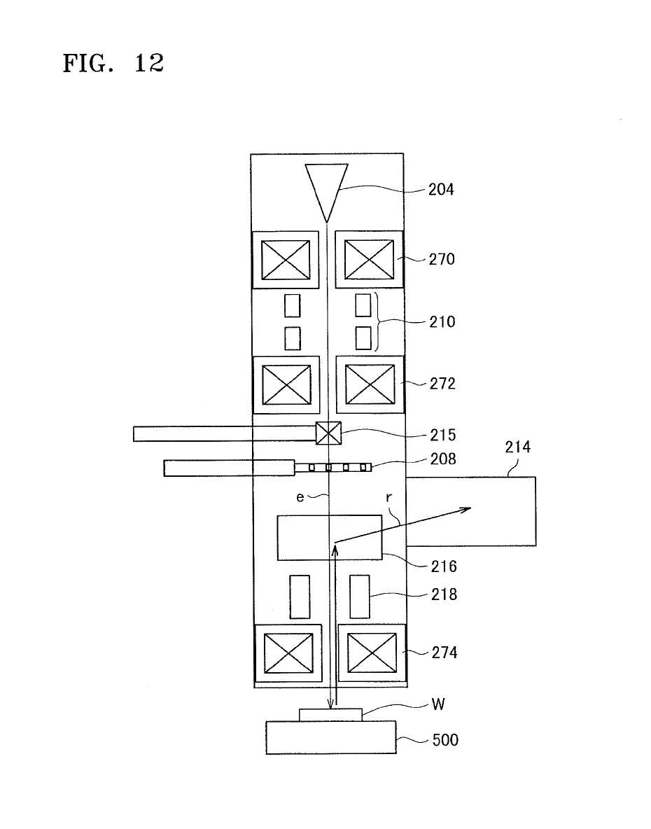

FIG. 11 illustrates another embodiment of an energy analyzer 214b in electron beam inspection apparatus 1000. Referring to FIG. 11, energy analyzer 214b includes a sector magnet 250 and a detector 252. A secondary electron beam r split by beam splitter 216 is introduced into sector magnet 250. The sector magnet 250 may be an electromagnet having an N pole and an S pole disposed in directions perpendicular to ground in FIG. 11, with secondary electron beam r therebetween.

The detector 252 detects a current Is for incident secondary electron beam r, and current Is indicates a spectrum intensity (e.g., corresponding to a horizontal axis of FIG. 5) of secondary electron beam r. Even in energy analyzer 241b of FIG. 11, characteristics of FIG. 5 may be obtained by detecting current Is while changing adjustment voltage VG, determined by an adjustment current of sector magnet 250 and by plotting adjustment voltage VG to a vertical axis and current Is to the horizontal axis.

A depth position of a defect is detected based on the obtained characteristics of FIG. 5. For example, energy analyzer 402 of computer 400 receives current Is and adjustment voltage VG, and obtains the characteristics of FIG. 5. The detection unit 404 detects a depth position of a defect based on the characteristics of FIG. 5 obtained by energy analyzer 402. Also, a relationship (e.g., characteristics of FIG. 7) between energy at a peak of the characteristics of FIG. 5 and a depth of the defect, which has been previously obtained, is stored in memory unit 406.

Also, when a defect is detected in a typical defect detection mode, coordinate obtaining unit 408 of computer 400 obtains a coordinate of the defect in a planar direction of a sample from a position of stage 500. Alternatively, coordinate obtaining unit 408 may obtain the coordinate of the defect detected by another device from the device.

FIG. 12 illustrates an embodiment of electron beam column 200 using a magnetic lens in electron beam inspection apparatus 1000. Although electron beam column 200 of FIG. 2 uses an electrostatic lens, a magnetic lens may be used as shown in FIG. 12. In FIG. 12, a condenser lens 270 using a magnetic lens is provided instead of condenser lens 206 of FIG. 2, and a blanking lens 272 using a magnetic lens is provided instead of blanking electrode 212 of FIG. 2. Also, in FIG. 12, an objective lens 274 using a magnetic lens is provided instead of objective lens 220 of FIG. 2. As such, electron beam column 200 may be configured using a magnetic lens.

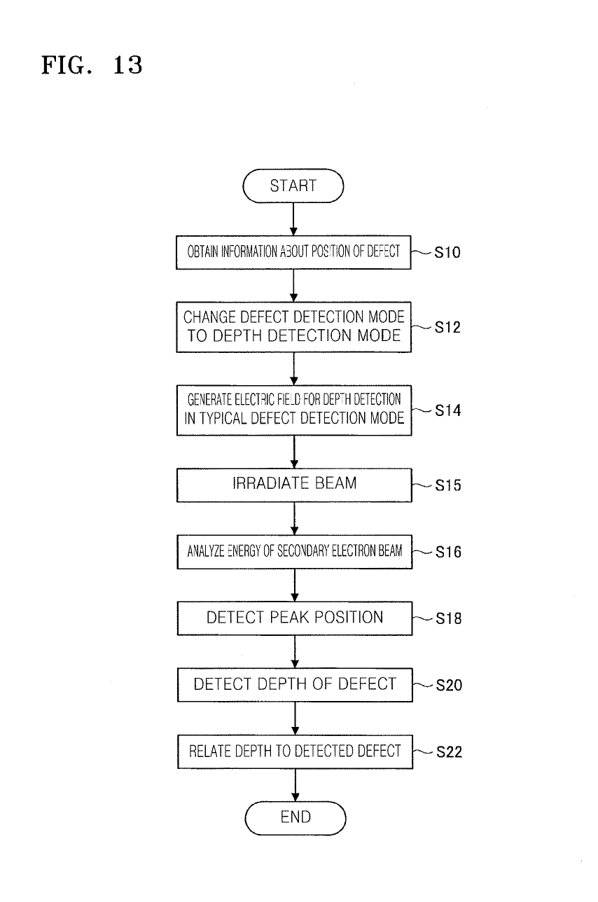

FIG. 13 illustrates an embodiment of a defect inspection process of the electron beam inspection apparatus 1000. Referring to FIG. 13, first, in operation S10, information about a position of a defect is obtained. The electron beam inspection apparatus 1000 detects the defect on wafer W in a typical defect detection mode. Accordingly, the position (e.g., coordinate) of the defect formed due to dust or the like attached to contact hole C is obtained based on a position of stage 500.

In addition, although electron beam inspection apparatus 1000 detects the position of the defect in the typical defect detection mode in FIG. 13, the present embodiment is not limited thereto. For example, another device may detect the defect, and electron beam inspection apparatus 1000 may obtain the position (coordinate) of the defect from the device.

Next, in operation S12, electron beam column 200 is moved to the position of the defect detected in the typical defect detection mode to observe the defect. Then, the typical defect detection mode is changed to a depth detection mode, in which the depth of the defect is detected.

Next, in operation S14, an electric field for depth detection is generated between the objective lens 220 and a sample. An electric field may be generated even in the typical defect detection mode of operation S10.

Next, in operation S15, a beam of electron beam e is spot-irradiated to contact hole C in the depth detection mode. Alternatively, a beam having a size equal to or greater than a diameter of contact hole C is irradiated to contact hole C.

Next, in operation S16, energy of secondary electron beam r, generated in the defect due to emission of the beam, is analyzed. In this case, characteristics indicating a relationship between a spectrum intensity and energy of FIG. 5 are obtained by scanning pass energy (adjustment voltage VG) of energy analyzer 214 as described above. Energy of the secondary electron beam r generated in the defect is analyzed based on the obtained characteristics.

Next, in operation S18, a peak position of a spectrum of secondary electron beam r (a peak of secondary electrons and a peak of Auger electrons) and a raised position of the spectrum (about 0V) are detected from the obtained characteristics of FIG. 5.

Next, in operation S20, a depth of the defect is detected based on energy at the peak position detected in operation S18. This may be performed by referring to a database that stores data obtained after measuring a relationship between energy and a depth of a defect for an insulator having a given thickness. Also, an energy difference of emitted electrons and a potential distribution at a depth position of the defect in contact hole C may be calculated from a thickness of insulating film 10 of the sample, a working distance (e.g., between an end of objective lens 220 and wafer W), a voltage of the sample, and/or a quantity of electric charge which have been previously input.

Next, in operation S22, the depth detected in the depth detection mode is related to the defect detected in the typical defect detection mode. Next, a depth is detected in the same order by moving to a position of a next defect. When there is no further defect, the defect inspection process is finished.

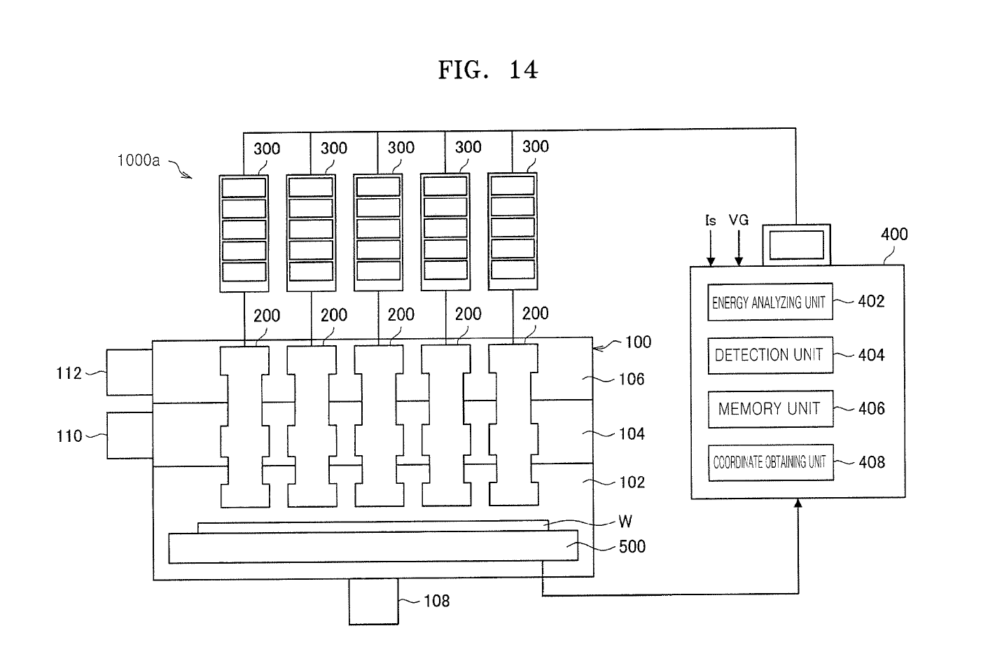

FIG. 14 illustrates another embodiment of an electron beam inspection apparatus 1000a, which includes a plurality of electron beam columns 200 in chamber unit 100. In FIG. 14, electron beam inspection apparatus 1000a may receive the plurality of electron beam columns 200 in chamber unit 100. When the electron beam columns 200 are received in chamber unit 100, a plurality of control power supply sources 300 may be provided, such that one control power supply source 300 is allocated to one electron beam column 200. When the electron beam columns 200 are received in chamber unit 100, a defect on wafer W may be detected in a wider range due to the plurality of electron beam columns 200, thereby leading to faster defect inspection.

As described above, according to the one or more embodiments, an electron beam inspection apparatus and an electron beam inspection method may generate an energy difference of a secondary electron beam r corresponding to a depth position of a defect of a sample. This may be accomplished by applying an electric field E between an end of an electron beam column and the sample (wafer) and accelerating the secondary electron beam r (generated due to emission of electron beam e) to the sample using electric field E. Accordingly, a depth of the defect may be very precisely detected by comparing peak positions of energy of the secondary electron beam r generated in the defect.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. An electron beam inspection apparatus, comprising:
an electron beam irradiating unit to irradiate an electron beam on a sample;
an electric field generating unit to generate an electric field in an irradiation direction of the electron beam;
an energy analyzing unit to analyze energy of electrons emitted from the sample caused by emission of the electron beam, the electrons accelerated by the electric field; and
a detection unit to detect a depth position of a portion to which the electrons are emitted in the irradiation direction of the electron beam based on a result of the energy analysis.

2. The apparatus as claimed in claim 1, wherein the detection unit is to detect a depth position of a defect based on a relationship between the energy of the electrons and a spectrum intensity based on the result of the energy analysis.

3. The apparatus as claimed in claim 1, wherein the energy analyzing unit is to obtain characteristics indicating a relationship between the energy of the electrons and a spectrum intensity, the characteristics to be obtained by scanning pass energy of the emitted electrons, and the energy of the electrons to be analyzed based on the obtained characteristics.

4. The apparatus as claimed in claim 3, wherein the detection unit is to detect the depth position based on the energy of the electrons at a peak position of the spectrum intensity in the obtained characteristics.

5. The apparatus as claimed in claim 4, further comprising:
a memory unit to store a correlation between the energy of the electrons and the depth position at the peak position of the spectrum intensity, wherein the detection unit is to detect the depth position based on a correlation stored in the memory unit.

6. The apparatus as claimed in claim 1, wherein the detection unit is to detect the depth position of a defect generated in the sample based on the analyzed energy of the electrons.

7. The apparatus as claimed in claim 6, wherein the electron beam irradiating unit is to irradiate the electron beam as a beam having a size substantially equal to or greater than a width of a deep groove in the sample.

8. The apparatus as claimed in claim 6, further comprising:
a coordinate obtaining unit to obtain a coordinate of the defect,
wherein the detection unit is to detect the depth position of the defect having the coordinate obtained by the coordinate obtaining unit.

9. The apparatus as claimed in claim 1, wherein:
the electron beam irradiating unit is provided in one electron beam column, and
the electron beam inspection apparatus includes at least one electron beam column.

10. An electron beam inspection apparatus, comprising:
at least one electron beam column including:
an electron beam irradiating unit to irradiate an electron beam on a sample, and
an energy analyzer to detect electrons emitted from the sample due to emission of the electron beam, the emitted electrons accelerated by an electric field;
an electric field generating unit to generate the electric field in an irradiation direction of the electron beam to accelerate the emitted electrons; and
a detection unit to receive an output signal from the energy analyzer, analyze energy of the electrons, and detect a depth position of a portion to which the electrons are emitted in the irradiation direction of the electron beam based on a result of the analysis.

11. The apparatus as claimed in claim 10, wherein the electric field generating unit is to generate the electric field by applying a voltage between an objective lens of the electron beam irradiating unit and the sample, or by charging the sample with a predetermined number of electric charges.

12. The apparatus as claimed in claim 10, wherein the energy analyzer includes an energy filter having a grid electrode and a detector to detect electrons passing through the energy filter.

13. The apparatus as claimed in claim 10, wherein the energy analyzer includes a path that includes concentric hemispheres and a detector that includes a slit and that detects the electrons.

14. The apparatus as claimed in claim 10, wherein the energy analyzer includes a sector magnet that includes an electromagnet and a detector that includes a slit and that detects the electrons.

15. The apparatus as claimed in claim 10, further comprising:
a plurality of electron beam columns; and
two or more control power supply sources respectively allocated to the two or more electron columns and to input a scan voltage into the two or more electron columns.

16. An electron beam inspection apparatus, comprising:
an irradiator to direct an electron beam on a sample;
a generator to generate an electric field for the electron beam;
an analyzer to analyze energy of electrons emitted from the sample; and
a detector to detect a depth position of the emitted electrons based on a result of the energy analysis, wherein the depth position is in alignment with a direction in which the electron beam is directed toward the sample.

17. The apparatus as claimed in claim 16, wherein the electric field is to extend between an end of an electron beam column and the sample.

18. The apparatus as claimed in claim 16, wherein the electrons emitted from the sample are to be accelerated by the electric field.

19. The apparatus as claimed in claim 16, wherein the detector is to detect the depth position based on a comparison of peak positions of energy of the electrons emitted from the sample.

20. The apparatus as claimed in claim 16, wherein the depth position of the emitted electrons corresponds to a contact hole formed on the semiconductor wafer.
